(19) United States
(12) Patent Application Publication
(10) Pub. No.: US 2009/0178267 A1
(43) Pub. Date: Jul. 16, 2009

(54) ID Clip For Yoga Mat

(76) Inventor: Helena Zera Axelrod, Jamesville, NY (US)

Correspondence Address: PASTEL LAW FIRM;CHRISTOPHER R. PASTEL, 8 PERRY LANE, ITHACA, NY, 14850-9267, US

(21) Appl. No.: 12/351,825

(22) Filed: Jan. 10, 2009

Related U.S. Application Data
(60) Provisional application No. 61/020,322, filed on Jan. 10, 2008.

(51) Int. Cl. A44B 21/00; B23P 13/04

(52) U.S. Cl. 29/557; 24/457

(57) ABSTRACT

An identification clip for a yoga mat includes a first section, a second section, and a third section, the first section being joined to the third section via the second section, and the second section having curved edges. The first section includes a user's name cut therethrough. The second section is bent such that the first section and the third section form parallel planes, fitting over a side of the mat, so that the color of the mat forms a background relief for the name cut through the clip.

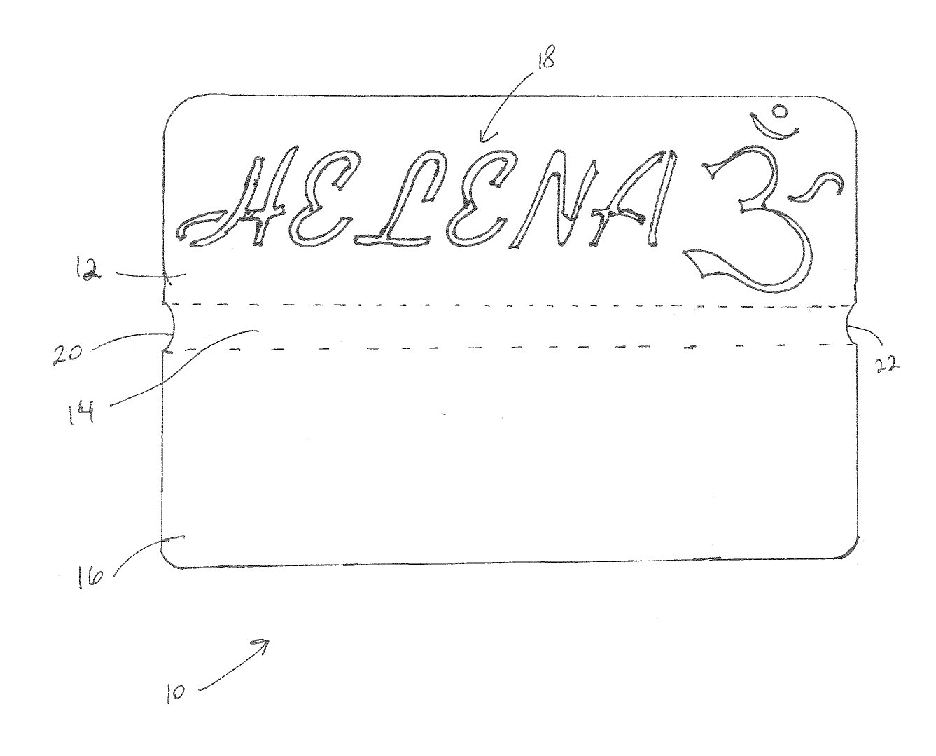

### CROSS-REFERENCE TO RELATED APPLICATIONS

This application claims priority from U.S. Provisional Application Ser. No. 61/020,322 filed on Jan. 10, 2008 and entitled ID CLIP FOR YOGA MAT, incorporated herein by reference.

### FIELD OF THE INVENTION

This invention relates generally to the field of identification clips, and more particularly to an identification clip designed for a yoga or other exercise mat.

### BACKGROUND OF THE INVENTION

Yoga workouts and practice sessions often include exercises and positions that are not executed on a yoga mat. In group sessions, returning to one's own mat can be confusing, due to the similarity between mats, thus interfering with the peaceful mind-state often achieved during the practice of yoga. A way of marking one's own yoga or exercise mat would be useful.

### SUMMARY OF THE INVENTION

Briefly stated, an identification clip for a yoga mat includes a first section, a second section, and a third section, the first section being joined to the third section via the second section, and the second section having curved edges. The first section includes a user's name cut therethrough. The second section is bent such that the first section and the third section form parallel planes, fitting over a side of the mat, so that the color of the mat forms a background relief for the name cut through the clip.

According to an embodiment of the invention, an identification clip for an exercise mat used by a user includes a first section; a second section; a third section; wherein the first section is joined to the third section via the second section; wherein the second section consists of side cuts; wherein the second section is bent such that the first section and the third section form parallel planes with each other; wherein a distance between the parallel planes formed by the first section and the third section is at least a smidge greater than a thickness of the exercise mat; and wherein a name of the user is contained within the first section.

According to an embodiment of the invention, a method of manufacturing an identification clip for an exercise mat includes the steps of: (a) providing a single blank of metal, wherein the blank consists of a first section, a second section, and a third section; (b) wherein the first section is joined to the third section via the second section; (c) cutting side cuts into the second section; (d) cutting a specified name into the first section, wherein the name is cut entirely through a thickness of the blank; and (e) bending the clip into a “U”-shape such that the second section forms a base of the “U” and the first section and the third section form parallel planes to each other, wherein a distance between the parallel planes formed by the first section and the third section is at least a smidge greater than a thickness of the exercise mat.

According to an embodiment of the invention, a method of manufacturing an identification clip for an exercise mat includes the steps of: (a) providing a plastic blank consisting of a first section, a second section, and a third section, wherein the first section is joined to the third section via the second section; (b) forming the plastic blank into a “U”-shape such that the second section forms a base of the “U” and the first section and the third section form parallel planes to each other, wherein a distance between the parallel planes formed by the first section and the third section is a smidge greater than a thickness of the exercise mat; and (c) forming a specified name into the first section, wherein the name extends entirely through a thickness of the first section.

### BRIEF DESCRIPTION OF THE DRAWINGS

The FIGURE shows a top view of an identification clip according to an embodiment of the invention.

### DETAILED DESCRIPTION OF THE PREFERRED EMBODIMENT

Referring to the FIGURE, an identification (ID) clip 10 fits over a mat (not shown) for identification purposes. The mat is preferably a yoga mat, but is optionally a pilates mat or any exercise mat that is traditionally between ⅛ inches thick to 1 inch thick. ID clip 10 is generally rectangular in shape, with comers preferably rounded, and consists of three sections, a first section 12 which has room for a name 18 of a user, a second section 14, and a third section 16. Second section 14 preferably includes side cuts 20 and 22 which aid in bending third section 16 until third section 16 is parallel to first section 12. The bend preferably occurs entirely in second section 14.

The bent ID clip 10 is then fitted over the mat, after which first section 12 and third section 16 are preferably squeezed together to ensure ID clip 10 is fitted securely to the mat. No rivets or other fastenings are desired or required to affix ID clip 10 to the mat.

The name 18 can be engraved onto first section 12, or adhesive letters can be stuck onto first section 12, but the preferable method of forming the name is to cut the letters of the name out of first section 12 so that the name is formed by the contrast in colors between the color of the mat and the color of ID clip 10. The cutting can be done by laser cutting or done using a abrasive jet. When using the abrasive jet, a directional grain is preferably applied to the first section 12 which eliminates the burr from the underside and removes the residual halo released from the overspray of the abrasive jet. A urethane die is then preferably used to compress ID clip 10 into a “U”-shape, which allows the material to form nearly 180 degrees in one stroke. ID clip 10 is preferably made of stainless steel, brass, or copper, but can be made of plastic.

The length of first section 12 varies between 4 to 8 inches depending on the number of letters in the name 18, with the width (height) of first section 12 being preferably 2.5 inches. Third section 16 is preferably the same length as first section 12, but may be a different length. The combined width of second section 14 and third section 16 is approximately the same width as first section 12, i.e., 2.5 inches, or alternately, the width of the first and third sections is the same. The width of second section 14 depends

For purposes of this patent application, a “smidge” is defined as a “slight amount”, or a “tad”, such that the first and third sections 12, 16 of “U”-shaped ID clip 10 slides over an edge of the exercise mat, but once on the mat, preferably forms a slight interference fit with the mat. The smidge in difference between the width (i.e., the distance between the parallel planes formed by first section 12 and third section 16) of the folded ID clip 10 and the width of the exercise mat is necessary to permit slipping ID clip 10 over the exercise mat before crimping ID clip 10 onto the exercise mat. When ID clip 10 is made of plastic instead of metal, crimping is impossible, so the smidge in difference becomes more critical than when made of metal, so that ID clip 10 fits over the mat but does not slide off, i.e., ID clip 10, when made of plastic, must form an interference fit with the mat when slid over the edge of the mat. The preferred thickness for all three preferred metals is 20 gauge with a matte finish.

While the present invention has been described with reference to a particular preferred embodiment and the accompanying drawings, it will be understood by those skilled in the art that the invention is not limited to the preferred embodiment and that various modifications and the like could be made thereto without departing from the scope of the invention as defined in the following claims.

What is claimed is:

1. An identification clip for an exercise mat used by a user, comprising:
a first section;
a second section;
a third section;
wherein the first section is joined to the third section via the second section;
wherein the second section consists of side cuts;
wherein the second section is bent such that the first section and the third section form parallel planes with each other;
wherein a distance between the parallel planes formed by the first section and the third section is at least a smidge greater than a thickness of the exercise mat; and
wherein a name of the user is contained within the first section.

2. An identification clip according to claim 1, wherein the name is cut entirely through a thickness of the first section.

3. An identification clip according to claim 2, wherein the clip is made of metal.

4. An identification clip according to claim 1, wherein the clip is made of metal.

5. A method of manufacturing an identification clip for an exercise mat, comprising the steps of:
providing a single blank of metal, wherein the blank consists of a first section, a second section, and a third section;
wherein the first section is joined to the third section via the second section;
cutting side cuts into the second section;
cutting a specified name into the first section, wherein the name is cut entirely through a thickness of the blank; and
bending the clip into a “U”-shape such that the second section forms a base of the “U” and the first section and the third section form parallel planes to each other;
wherein a distance between the parallel planes formed by the first section and the third section is at least a smidge greater than a thickness of the exercise mat.

6. A method of manufacturing an identification clip for an exercise mat, comprising the steps of:
providing a plastic blank consisting of a first section, a second section, and a third section, wherein the first section is joined to the third section via the second section;
forming the plastic blank into a “U”-shape such that the second section forms a base of the “U” and the first section and the third section form parallel planes to each other, wherein a distance between the parallel planes formed by the first section and the third section is a smidge greater than a thickness of the exercise mat; and
forming a specified name into the first section, wherein the name extends entirely through a thickness of the first section.
